(19) United States
(12) Patent Application Publication
(10) Pub. No.: US 2006/0077593 A1
(43) Pub. Date: Apr. 13, 2006

(54) Slider, manufacturing method thereof, and head suspension assembly with the same

(75) Inventor: Kunihiro Ueda, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/245,476

(22) Filed: Oct. 7, 2005

(30) Foreign Application Priority Data
Oct. 8, 2004 (JP) 2004-295901

(51) Int. Cl. G11B 5/60

(52) U.S. Cl. 360/235.1

(57) ABSTRACT

A slider of the invention includes a substrate, a head element formed on the substrate and a protecting film formed on at least one portion of one surface of the substrate facing a magnetic recording medium. The protecting film comprises a base film, first DLC (diamond like carbon) film adjacent the substrate and a second DLC film. The carbon film density of said first DLC film is less than 3.1 (g/cm3) and the carbon film density of said second DLC film is more than 3.1 (g/cm3).

### FIELD OF THE INVENTION

The present invention relates to a slider incorporating a thin protecting film which is wearable and corrosive-resistant, and manufacturing method of the slider, and a head suspension assembly (HSA) incorporating the slider.

### BACKGROUND OF THE INVENTION

Disk drives have been widely used as external storage devices of small computer systems.

Presently, disk drives are developed to have a high storage density while having a low profile and big storage capacity. So, it is provided that a slider comprising a substrate and a head element formed on the substrate by thin-film technology. In these sliders, many reading head elements, such as AMR (anisotropy magneto-resistive) element, GMR (giant magneto-resistive) element and TMR (tunnel magneto-resistive) have been developed for satisfying a requirement of high recording density. In addition, a CPP (current perpendicular to plane) type GMR element can also be used as a reading head element in the sliders.

Also, a compound slider is commonly used which has a structure that on its head reading element, an induction magnetic transducer element is laminated as a storage head element.

As illustrated, the slider comprises a substrate and a head element formed on the substrate, here, because an end surface (air bearing surface, ABS) of a metal layer for forming the head element is exposed opposite to the magnetic recording medium, it is necessary to take some anti-corrosive measures to protect the ABS from being corroded. In addition, it is necessary to take measures to keep sway performance of ABS (i.e. increasing contact times) good for a long time, thus preventing the slider from collision or/and magnetic recording medium from scratching.

Particularly, in CSS (current start stop) type disk drive, because the surface of the disk contacts with ABS of the slider when starting and ending a drive operation, it is more desired for ABS of the slider to have a good sway performance (i.e. low friction performance). Accordingly, in prior art, a protecting film is provided on ABS of the slider for protecting the end surface of the metal layer for forming the head element and thus improving the anti-corrosive performance and sway performance of the slider. In addition, for achieving a high recording density, an interval between the metal layer (especially the magnetic layer) for forming the head element and the magnetic film of the magnetic recording medium should be reduced as small as possible, and the thickness of the above-mentioned protecting film should be kept as thin as possible.

In the conventional sliders, the aforementioned protecting film is constructed from a double-layer film which comprises a base film constructed by silicon or silica film and a diamond like carbon (DLC) film formed on the base film (referring to Japanese patent application publication No. 8-297813 and No. 9-91620).

As it is difficult to attach the DLC film onto a metallic film of Fe or Fe alloy, accordingly, it is very difficult to directly form and tightly bond the DLC film on the metal. Then, in related arts, a base film constructed from silicon or silica film is provided to serve as a bonding layer for attaching the DLC film to the metal. Additionally, the bonding performance of the DLC film will be enhanced due to application of the base film which consisting of silicon or silica material having both an organic and inorganic character.

Furthermore, a protecting film is disclosed in Japanese patent application publication No. 2002-8217, which has a good sway performance, wearable performance and corrosive-resistive performance even when its thickness is less than 5 nm and its floating amount is below 20 nm. In the related art, a hydrogenous noncrystalline carbon film comprising 5-50 atm % hydrogen element is disposed between a high-hardness noncrystalline carbon film and the substrate or buffer layer (Si or SiC film etc.) The hydrogenous noncrystalline carbon film has a carbon element purity more than 95 atm % and its SP3 bonding more than 70% corresponding to the surface of the magnetic recording medium.

However, in Japanese patent application publication No. 2002-8217, because the two carbon films with completely different characteristic are used concurrently, a long term protection (including protection from vibration) will not be achieved even if a short term protection can be gotten. Moreover, the protective thin film has a complex structure and it is difficult to control manufacturing process for forming the desirable protective thin film so as to make the thin film not reliable.

Other related arts, which are disclosed in Japanese patent application publication No. 8-297813, Japanese patent application publication No. 9-91620 and Japanese patent application publication No. 2002-8217, respectively.

### SUMMARY OF THE INVENTION

To overcome the drawbacks of the related arts, a main aspect of the present invention is to provide a slider having a durable, wearable and corrosive-resistive protecting thin film, a manufacturing method thereof, and a head suspension assembly (HSA) with the slider.

To achieve above objects, the slider provided by the instant invention includes a substrate, head elements formed on the substrate and a protecting film formed on at least one portion of one surface of the substrate, wherein said surface faces a magnetic recording medium. Viewed from one surface of the substrate, said protecting film comprises in turn a first DLC (diamond like carbon) film and a second DLC film, wherein the carbon film density of said first DLC film is less than 3.1 (g/cm³), whereas the carbon film density of said second DLC film is more than 3.1 (g/cm³).

Preferably, according to one embodiment of the slider provided by the invention, a base film made mainly from silicon element is disposed between said substrate and said first DLC film.

Preferably, according to one embodiment of the slider provided by the invention, said base film made mainly from silicon element is constructed by material such as silicon, silica, silicon nitride or carborundum.

Preferably, according to one embodiment of the slider provided by the invention, the thickness of said first DLC film ranges within 0.5-2.0 nm, while the thickness of said second DLC film is within 1.0-2.0 nm.

Preferably, according to one embodiment of the slider provided by the invention, the surface resistance of the protecting film is within 10⁷-10¹⁰ ohms.

In addition, a manufacturing method of the slider provided by the invention comprises a step of forming head elements on a substrate, and a step of forming a protecting film on at least one portion of one surface of the substrate facing a magnetic recording medium, wherein the step of forming the protecting film further comprises a step of forming base film which is principally made from silicon element on said substrate; a step of forming a first DLC film on said base film such that the slider is grounded or floated; a step of forming a second DLC film on said first DLC film using catholic arc method and by applying bias on said first DLC film, said bias value ranging from −25V to −150V.

Preferably, according to one embodiment of the manufacturing method of the slider provided by the invention, said bias value ranges from −25V to −100V.

Preferably, according to one embodiment of the manufacturing method of the slider provided by the invention, regarded as a preprocessing before forming said base film, a cleaning process is performed to clean the surface of the base film by ion beam etching (IBE) method.

Preferably, according to one embodiment of the manufacturing method of the slider provided by the invention, said protecting film extends to at least a metal layer of the surface of the head element facing the magnetic recording medium.

Additionally, the present invention also includes a slider and a suspension, said slider is carried by said suspension at it's distal end and supported by said suspension, wherein said slider comprises a substrate, a head element formed on the substrate and a protecting film formed on at least one portion of one surface of the substrate, and said surface faces the magnetic recording medium. Viewed from one surface of the substrate, said protecting film comprises in turn a base film mainly consisting of silicon element, a first DLC (diamond like carbon) film and a second DLC film, wherein the carbon film density of said first DLC film is less than 3.1 (g/cm³), whereas the carbon film density of said second DLC film is more than 3.1 (g/cm³).

The slider provided by the invention includes a substrate, a head element formed on the substrate and a protecting film formed on at least one portion of one surface of the substrate, wherein said surface faces the magnetic recording medium. Viewed from one surface of the substrate, said protecting film comprises in turn a first DLC (diamond like carbon) film and a second DLC film, wherein the carbon film density of said first DLC film is less than 3.1 (g/cm³), whereas the carbon film density of said second DLC film is more than 3.1 (g/cm³). By such structure, the slider of the invention takes advantages of very excellent long term wearability and corrosive-resistance which are not presented in conventional technology.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

FIG. 1 is a perspective view of a slider according to one embodiment of the invention;

FIG. 2 is an enlarged, cross-sectional view of an GMR element and an induction magnetic transducer element of the slider shown in FIG. 1;

FIG. 3 is a cross-sectional view of FIG. 2 taken along line A-A;

FIG. 4 is an enlarged view of the GMR element shown in FIG. 2;

FIG. 5 is a flow chart illustrating manufacturing method of the slider according to an embodiment of the invention;

FIG. 6 is a perspective view illustrating a process of forming a row bar from a wafer; and

FIG. 7 shows a plan view of a head suspension assembly (HSA) according to an embodiment of the invention.

### DETAILED DESCRIPTION OF ILLUSTRATED EMBODIMENTS

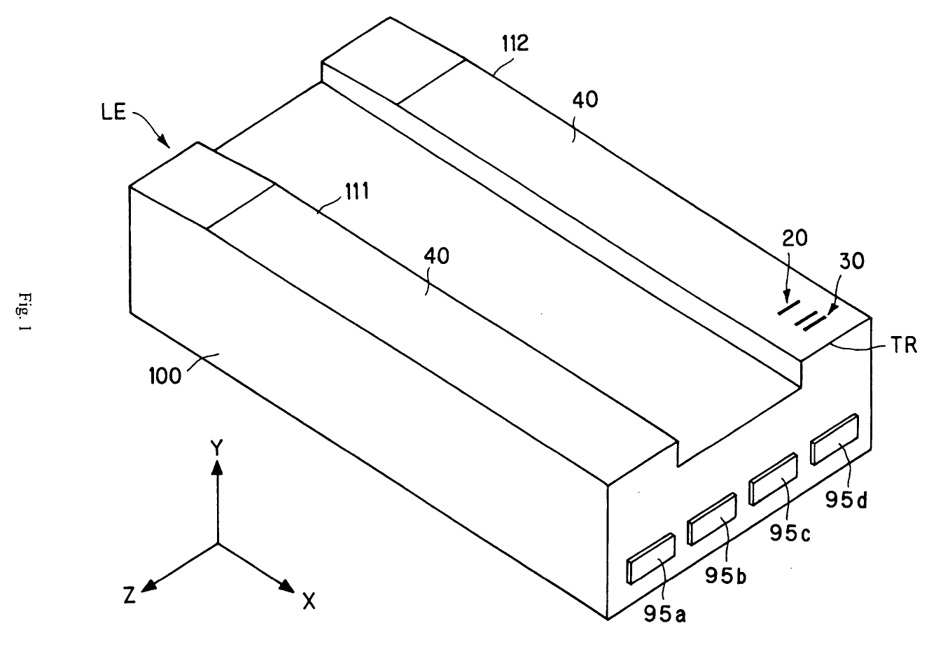

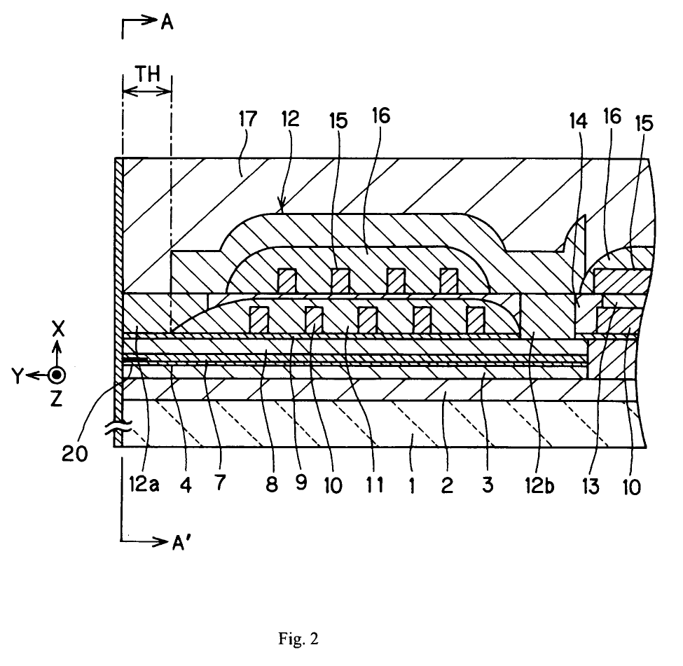

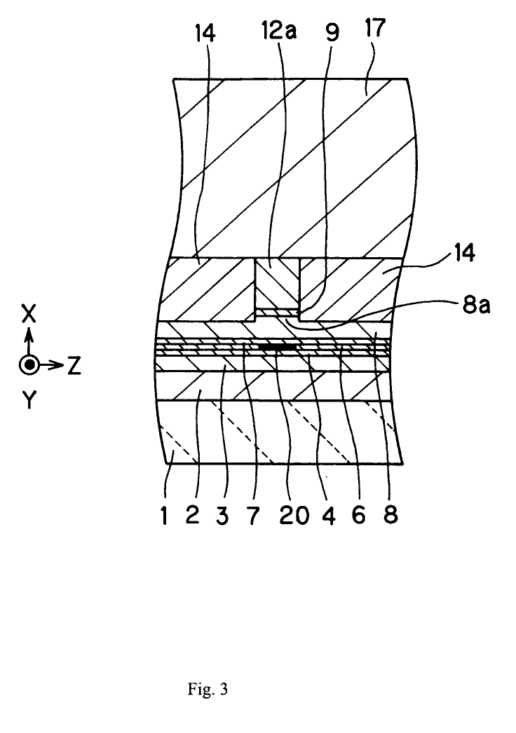

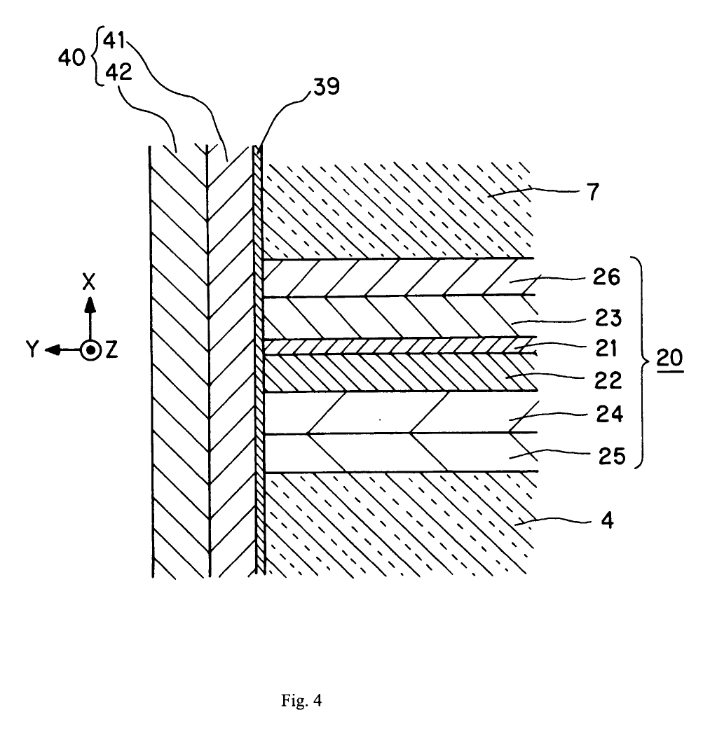

FIG. 1 is a perspective view of a slider according to an embodiment of the invention; FIG. 2 shows an enlarged, cross-sectional view of an GMR element and an inductive magnetic transducer element shown in FIG. 1; FIG. 3 is a partial view of FIG. 2 taken along line A-A; and FIG. 4 is an enlarged view of the GMR element shown in FIG. 2.

As shown in FIGS. 1-4, for purpose of easily understand, X-axis, Y-axis and Z-axis are defined in these figures (also apply to other figures of the invention), all of which are perpendicular to each other. X-axis is identical with moving direction of magnetic recording medium.

As illustrated in FIG. 1, according to an embodiment of the invention, a slider comprises a head slider 100 which is an embodiment of the above-mentioned substrate, a GMR element 20 as a head element for reading, an induction magnetic transducer element 30 as a head element for writing, and a protecting film 40. All of the elements/components form a compound slider.

Also, instead of using the GMR element 20, the slider of the invention can utilize other type of reading head element such as TMR element or AMR element, or only have a reading element or writing element. In the embodiment, only a reading element 20 and a writing element 30 are provided, however, it is understood that the number of the reading elements and writing elements is not limited to the amount of the embodiment.

The head slider 100 comprises two magnetic rails 111,112 in a side facing to the magnetic recording medium. The surfaces of the two magnetic rails 111, 112 constitute the air bearing surface (ABS) of the slider. It is noted that the number of the magnetic rails is not limited to two as shown in FIG. 1, for example, the number of the magnetic rails may be one, two or three, and the ABS may be a plat surface without any magnetic rail. Furthermore, various patterns may be formed on the ABS for improving the floating performance. Also, any suitable type of the sliders may be used in the invention.

In this embodiment, the protecting film 40 is provided on the surfaces of the magnetic rails 111, 112 which constitute the ABS of the slider. Of course, the protecting film 40 may cover the whole surface of the head slider 100 facing to the magnetic recording medium. In the embodiment, the protecting film 40 covers the whole surfaces of the head elements 20, 30 facing to the magnetic recording medium, i.e., the protecting film 40 extends at least to a metal layer on the surface of the head elements 20, 30 facing to the magnetic recording medium. A more detailed description of the protecting film 40 will be described later.

As illustrated in FIG. 1, the GMR element 20 and the induction magnetic transducer element 30 are provided at a side adjacent to the trailing edge TR of magnetic rails 111, 112. The moving direction of the magnetic recording medium is identical to the X-axis, i.e. identical to the air flow-out direction when the magnetic recording medium rotates in high speed. The air flows in from a leading edge LE of the slider and flows out from a trailing edge TR of the slider. On the trailing edge TR of the head slider 100, a plurality of connecting pads 95a, 95b are provided to connect with the GMR element 20, and a plurality of connecting pads 95c, 95d are provided to connect with the induction magnetic transducer element 30.

Referring to FIGS. 2-3, the GMR element 20 and the induction magnetic transducer element 30 are deposited on an undercoat 2 of a ceramic substrate 1 of the head slider 100. Generally, the ceramic substrate 1 is made of Al2O3-TiC. Because the Al2O3-TiC material is conductive material, so the undercoat 2 is formed from an insulator film made of Al2O3 material.

As illustrated in FIG. 4, the GMR element 20 includes a nonmagnetic layer 21, a ferromagnetic layer 22 deposited on one side of the nonmagnetic layer 21 and a soft magnetic layer 23 deposited on the other side of the nonmagnetic layer 21. Thus the nonmagnetic layer 21 is sandwiched between the ferromagnetic layer 22 and the soft magnetic layer 23. In the embodiment, the GMR element 20 further comprises an antiferromagnetic layer 24 (pin layer) deposited under the ferromagnetic layer 22, thus the magnetic field is biased by a cross bonding of the ferromagnetic layer 22 with the antiferromagnetic layer 24, and the ferromagnetic layer 22 acts as a datum layer which has a magnetization direction directed to a predetermined direction. In addition, the soft magnetic layer 23 acts as a free layer which magnetization direction can be changed freely to coincide with the external magnetic field which act as basic magnetic data. Furthermore, in the embodiment, the GMR element 20 also includes a base layer 25 deposited under the antiferromagnetic layer 24 and a cover layer (protective layer) 26 deposited on the soft magnetic layer 23.

As illustrated in FIG. 4, along Z-axis direction, a bias layer 6 (also referred as to a magnetic region controlling layer) is formed on both sides of the soft magnetic layer 23 for magnetic region control.

The ferromagnetic layer 22 and the soft magnetic layer 23 are made of materials such as Fe, Co, Ni, FeCo, NiFe, CoZrNb or FeCoNi. The nonmagnetic layer 21 is made of material such as Cu film. The antiferromagnetic layer 24 is made of Mn system material, such as IrMn alloy, FeMn alloy, NiMn alloy or PtMn alloy, or made of oxide materials, e.g. Fe₂O₃ or NiO. The base layer 25 is made of materials, such as Ta, Hf or Nb. The cover layer 26 is made of materials such as Ta or Nb. The bias layer 6 is made of hard magnetic materials, such as Co, TiW/CoP, or TiW/CoCrPt.

Referring to FIGS. 2-4, in the GMR element 20, a first covering layer 4 and a second covering layer 7 are positioned between a bottom magnetic-shielding layer 3 and a top magnetic-shielding layer 8, and both of the magnetic-shielding layers 3, 8 are made of magnetic material such as NiFe. The bottom magnetic-shielding layer 3 is provided on the undercoat 2.

The GMR element 20 also utilizes a conductive layer (not shown) to electrically connected the connecting pads 95a and 95b.

As illustrated in FIGS. 2-3, the induction magnetic transducer element 30 comprises a bottom yoke layer 8 (also function as the top magnetic-shielding layer 8 of the GMR element 20), a top yoke layer 12 (12a), coil layers 10 and 15 which constitute by two portions, a write gap layer 9 made of material such as alumina, insulator layers 11 and 16 made of organic resin e.g., novolac, and an overcoat 17 made of material such as alumina. The yoke layers 8 and 12 can be made of NiFe or FeN. The write gap layer 9 is made of thin material such as alumina to space the frond ends of the yoke layers 8 and 12 from each other, thus forming a bottom pole 8a and a corresponding top pole 12a to read data from and write data to the magnetic recording medium. Reference number 14 denotes an insulator layer. A connection portion located between the yoke layers 8 and 12 is connected with a common portion 12b located in opposite sides of the bottom pole 8a and the top pole 12a so as to connect magnetic circuits together;

Embedded inside of the insulator layers 11 and 16 are swirling coil layers 10 and 15 both of which surround the common portion 12b. Both ends of the coil layers 10 and 15 are electrically connected with the connecting pads 95c and 95d. The coil layers 10 and 15 may have any suitable winding turns and winding layers. Also, the induction magnetic transducer element 30 may be of any suitable structure.

As illustrated in FIGS. 1-4, the protecting film 40 of the invention may be formed in a manner of covering the ABS deposition end surface of its consisting elements and the ABS surface of the ceramic substrate 1. On the end surface magnetic or nonmagnetic metallic layers of the GMR element 20 and induction magnetic transducer element are exposed. Without the protecting film 40, these metallic layers will be directly exposed to the air.

Preferably, before forming the protecting film 40, a material cleaning process and a base film forming process may be implemented. Generally, sputter etching as a cleaning process is used to gain cleaned surface. However, due to difficulty of PTR (pole tip recession) control, as a result, the effect of cleaning is not good. In the instant invention, an IBE (ion beam etching) method may be used to for the cleaning process. In the IBE method, controllable PTR and cleaned surface can be achieved at the same time by optimization of the incidence angle of the ion beam. Furthermore, the connectivity between the cleaned surface and the base film is improved, thus protection effect of the thin protecting film of the invention is ensured.

Preferably, before forming the protecting film 40, a process of forming a base film 39 on above-mentioned cleaned surface may be performed (base film forming process). The base film 39 functions as foundation of the protecting film 40 and is made mainly from silicon element. In the invention, DLC (diamond like carbon) films are provided to serve as protecting film, and due to connectivity between carbon and iron is poor, hereby the base film plays an important role in improving the connectivity performance. The base film may be made primarily from siliciferous material such as silicon, silica, silicon nitride or carborundum. The method of making the base film may include sputtering method or IBD (ion beam deposition) method. Due to application of energy in the IBD method, thus a thin film with very fine and tight surface may be produced. Therefore, the IBD method is recommended.

The protecting film 40 of the invention is positioned on the base film 39 and comprises a first DLC (diamond like carbon) film 41 adjacent the substrate 1 and a second DLC film 42 adjacent the first DLC film 41.

The first DLC film 41 is formed using method such as cathodic arc method on a condition where no bias voltage is applied. Namely, the first DLC film 41 is formed by cathodic arc method, under a state that the slider contacts with or floats on the substrate.

The carbon film density of the first DLC film 41 formed by aforementioned method is lower than 3.1 (g/cm³), specifically 2.7-3.1 (g/cm³), and preferably 2.8-3.0 (g/cm³). If the carbon film density is higher than 3.1 (g/cm³), the undercoat will not have a cushion function and problems such as bonding characteristic degradation will arise. The first DLC film 41 is formed to generally have a thickness of 3000 angstrom, and then it is weighed and its carbon film density is calculated. The thickness of the first DLC film 41 is measured by AFM (atomic force microscopy) method. Then, an acoustic transmission method is used to affirm the trend of the thickness and if the carbon film density reaches a desired value by transmission speed of sound. If the carbon film density is too high, the transmission speed of sound will become faster. Thus the condition for forming the first DLC film can be double-checked if it is normal or abnormal.

The hardness of the first DLC film 41 measured via diamond cone sclerometer is 20-50 GPa and the surface resistance thereof within 10E⁷-10E¹⁰ (Ω/cm).

The cathodic arc method is a method that applying voltage between a graphite bar and an electrode to produce electric arc, then ionizing the carbon of the graphite bar and making them vaporized by energy radiated from the electric arc, and driving these vaporized carbon ions to a base plate by inductive function of electromagnetic coils to these carbon ions, thus forming said thin film. The achieved thin film has a high hardness and a close surface because highly purified carbon is used as material in the method.

In related art, chemical vapor deposition (CVD) method is a commonly used method to a form a DLC film, however, in recent years, with the increasing demand for thin film performance, thin film with desirable protect function can not be attained easily, for example, an excellent DLC film can not be attained by using method such as ECR (Electron Cyclotron Resonance) type of plasma CVD.

The thickness of the first DLC film 41 of the invention is ranged from 0.5 to 2.0 nm, and preferably from 0.7 to 1.0 nm. When the thickness thereof is less than 0.5 nm, the anchor function of the first DLC film 41 will not take effect, namely, the arrangement of the first DLC film 41 will be meaningless. When the thickness thereof is larger than 2.0 nm, there is a trend that the hardness of all the films will be controlled by the first DLC film 41.

The second DLC film 42 is formed on said first DLC film 41. The second DLC film 42 is formed by cathodic arc method in a condition that a bias voltage is applied. The bias voltage is ranged from −25V to −150V, and preferably from −50V to −100V. The second DLC film 42 formed by the above method has a high hardness.

The carbon film density of the second DLC film 42 is higher than 3.1 (g/cm³), and preferably within 3.2-3.5 (g/cm³). If the carbon film density is lower than 3.1 (g/cm³), a good protecting effect against corrosion will not be obtained due to its low density. If the carbon film density is higher than 3.9 (g/cm³), the film will be broken because of too high hardness thereof. The measuring method of the carbon film density is identical to that of the first DLC film and a detailed description is omitted herein.

The thickness of the second DLC film 42 is within 1.0-2.0 nm, and preferably within 1.5-2.0 nm. When the thickness is lower than 1.0 nm, the arrangement of the second DLC film 42 will not have obvious effect (without a character of high hardness), so application of the protecting film will almost have no contribution to CSS (contact start stop) type of disk drive. In another aspect, when the thickness is higher than 2.0 nm, utilization of the protecting film on a high density slider will damage the gap.

As described above, the first DLC film 41 and the second DLC film 42 are deposited sequentially in a selection if the bias voltage will be applied. Namely, the first DLC film 41 is formed without application of the bias voltage, while the second DLC film 42 is formed with application of the bias voltage. The second DLC film 42 may be disposed on the outmost surface of the slider facing to the magnetic recording medium by film forming method described above so as to avoid generation of stress on the surface. Moreover, as long as the positions of the pinholes are not aligned with that of the first and second DLC films, through pinholes will not be formed thereon, and therefore, the protecting film even with extremely thin thickness will still present effective protect performance. In addition, in process of forming the second DLC film 42, even if the first DLC film 41 do has pinholes thereon, as the bias voltage concentrates on eyeable voltage areas, said second DLC film 42 can still be selectively formed on said first DLC film 41 according to the pinholes thereon, thus an effect for mending the pinholes is thus attained.

In case of not using the above described film forming method with two steps, namely, only directly forming the second DLC film with a high hardness thereon as a protecting film while not forming the first DLC film, the second DLC film easily peels from the slider under the action of the press in the film during usage, accordingly, a desirable protect effect will not be achieved.

The surface resistance of the second DLC film is ranged from 10⁷ to 10¹⁰ Ω, and preferably in a grade of 10E⁹ Ω. The surface resistance of the second DLC film mainly relies on the material of which the second DLC film is formed, which only comprises carbon element.

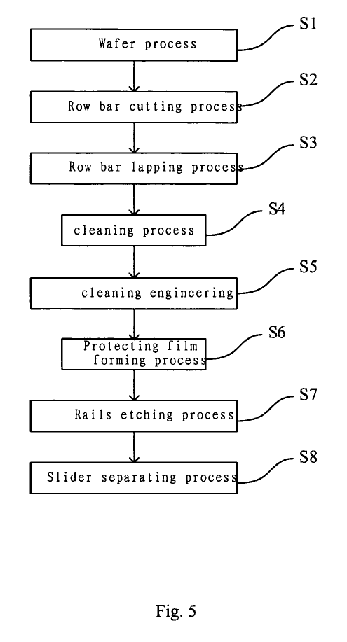

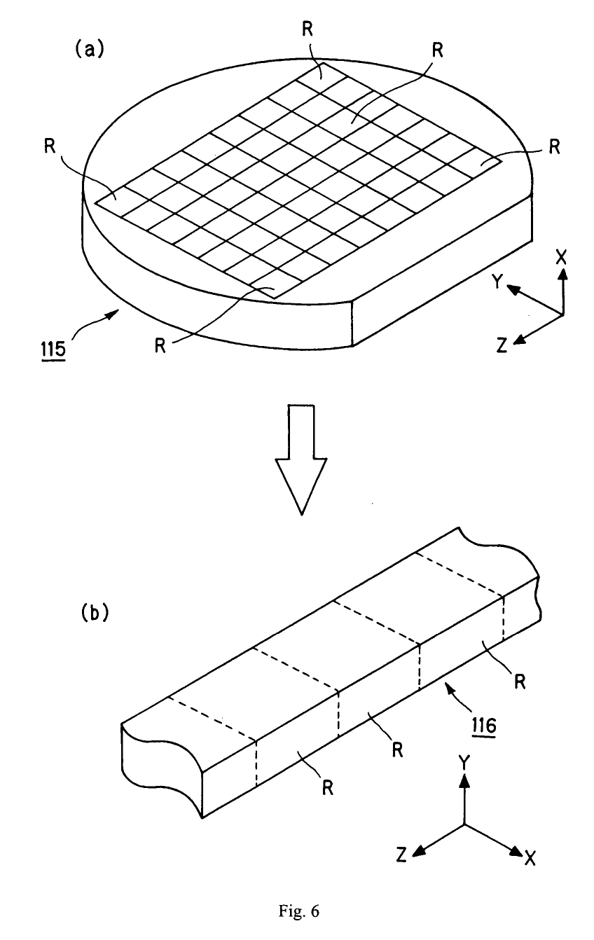

Now give a description about a manufacturing method of the slider in conjunction with FIGS. 5-6 according to one embodiment of the invention. FIG. 5 shows a flow chart illustrating a manufacturing method of a slider according to an embodiment of the invention and FIG. 6 is a perspective view illustrating a process of forming a row bar from a wafer.

Firstly a wafer process is performed (step S1). More specifically, in the process, utilizing the ceramic substrate 1 and Al₂O₃—TiC wafer 115 as shown in FIG. 6, a plurality of elements connecting with the connecting pads 95a-95d and a deposition film for forming the above-mentioned elements, which is different with the protective film 40, are formed on a plurality of rectangular regions of the head elements of a wafer 115 by thin film forming technology.

FIG. 6a shows a wafer 115 after the wafer process. In the figure, only regions R of the head elements are shown and the elements formed on the wafer 115 are not present.

Then, the wafer 115 shown in FIG. 6a is cut. The wafer 115 is cut into a number of row bars 116 by a cutter, such as diamond cutter (step S2, the row bar 116 is also referred as row bar slider aggregate). The row bar 116 comprises a plurality of sliders in rows on the substrate. FIG. 6b shows a formed row bar. In the figure, a top surface, ABS, of the row bar 116 is parallel to a XZ plane, on which end surfaces of the deposition film for forming the head elements shown in FIG. 2 are exposed. Also, the connecting pads 95a-95d in FIG. 1 are exposed on an exposed surface of the row bar 116 parallel to a YZ plane, as shown in FIG. 6b. These connecting pads 95a-95d are not present in FIG. 6b.

Then, the row bar 116 in FIG. 6b is lapped on its ABS side for setting appropriate pattern height and MR height, etc (step S3). In this step, the row bar 116 is secured to a fixture firstly, then contacts with an abrasive plate. After that, a suspension solution consisting of diamond polishing powder is introduced on the abrasive plate while the abrasive plate is rotated so that an ABS surface of the row bar 116 is lapped.

Consequently, the row bar 116 is cleaned (step S4). In the cleaning step, oil-bearing substance can be resolved or removed by a solvent, such as alcohol or by ultrasonic cleaning method. Understandably, the cleaning process here can be omitted according to actual process requirement.

As an embodiment, the protecting film 40 may be formed on the ABS surface of the row bar 116 directly. But a cleaning process (sputter etching or ion beam etching, step S5) is preferably performed before forming the protecting film 40. However, it is still desired to form a base film mainly consisting of silicon element after finishing the cleaning process.

As an embodiment of the invention, said protecting film 40 may be formed on the whole ABS surface of the row bar 116 on which the base film is deposited (step S6). Namely, under the condition that no bias voltage is applied (the condition that the slider contacting with or floating on the substrate and no bias voltage is applied), a first DLC film 41 is formed by cathodic arc method, and then a second DLC film 42 is formed with the bias voltage applied by cathodic arc method.

The protecting film 40 described above has very excellent performance of wearability and corrosive-resistance (as illustrated in the test results of the following embodiments) even when the thickness thereof is lower than 5 nm (ranged in 1-5 nm, especially 1-3 nm and more definitely 1-2 nm) comparing to the conventional film. Though not exactly, the main reason may be combination of the first DLC film 41 and the second DLC film 42 with different physical characteristic by a proper order produces multiplied wearable and corrosive-resistant effect that is more excellent than a summation effect to add simple effect of individual films together.

In the invention, excellent performance of wearability and connectivity may still be obtained by directly forming the protecting film 40 on the substrate. Therefore, the silicon or silica film served as a base film in conventional technology for improving bonding performance is not necessary in the invention.

After the step S6, selectively etching the ABS surface of the row bar 116 excluding the areas where the magnetic rails 111,112 are formed, so as to form the magnetic rails 111,112 (step S7). Finally, the row bar 116 is cut into respective sliders by mechanical process (step S8), thus forming the sliders of the invention.

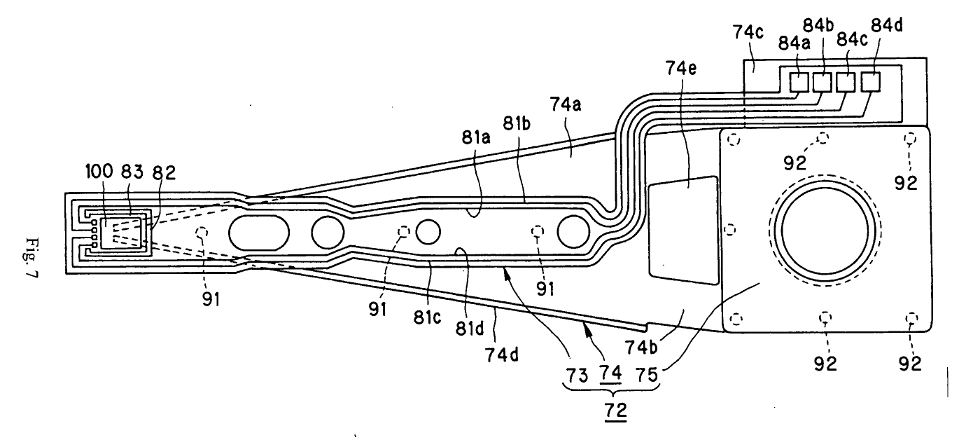

Now give a description of the embodiments of HSA FIG. 7 shows a plan view of a HSA according to one embodiment of the invention from a direction facing to magnetic recording medium.

The HSA of the embodiment comprises a slider having a head slider 100 and a suspension 72 for carrying the slider. The slider may be any suitable sliders described in above embodiments.

The suspension 72 comprises a flexure 73 on which the head slider 100 is carried, a load beam 74 which supports the flexure 73 and applies load to the head slider 100, and a base plate 75.

From a front end to a rear end of the flexure 73, the flexure 73 comprises a strip-shaped, elongated base portion (not shown) which is made of material, such as stainless steel; an insulator layer (not shown) made of material, such as polyimide, on the base portion; four conductive patterns 81a-81d formed on the insulator layer for reading and/or writing data; and an insulative overcoat on all of the above layers. The conductive patterns 81a-81d are formed along a longitudinal direction of the flexure 73 and has a length substantially as long as the whole length of the flexure 73.

The flexure 73 has a [symbol] shaped groove 82 at its front end and correspondingly a gimbal 83 is formed. The head slider 100 is mounted on the gimbal 83 by such as adhesive. The flexure 73 has four connecting pads at a portion thereof adjacent to the connecting pads 95a-95d (refer to FIG. 1) of the head slider 100, and said four connecting pads of the flexure 73 are electrically connected to the conductive patterns 81a-81d, respectively by such as gold ball bonding (GBB) or solder ball bonding (SBB). In addition, the flexure 73 further includes a plurality of bonding pads 84a-84d for connecting with an external circuit at its rear end, and the other ends of the conductive patterns 81a-81d are connected with these bonding pads 84a-84d, respectively.

The load beam 74 may be made of material such as thick stainless steel, which comprises a triangle-shaped rigid portion 74a at its front end; a connecting portion for connecting the base plate at its rear end; a resilient portion 74b which is located between the rigid portion 74a and the connecting portion and produces a press force to the head slider 100; and a support portion 74c extending from the connecting portion to a lateral side of the load beam 74 and supporting the load beam 74 at its rear end.

As illustrated in FIG. 7, a bending portion 74d is used to improve the rigidity of the rigid portion 74a, and an aperture 74e for adjusting the press force generated by the resilient portion 74b. The flexure 73 is mounted to the rigid portion 74a of the load beam 74 by a plurality of pinpoint 91 formed by such as laser welding. Similarly, the base plate 75 is attached to the connecting portion of the load beam 74 by a plurality of pinpoint 92 formed by such as laser welding. The rear end of the flexure 73 is supported by the support portion 74c of the load beam 74 which extends from the base plate 75 to the lateral side thereof.

The slider used herein may be the slider illustrated in the forgoing embodiments or their modifications. Therefore, by incorporating the HSA of the embodiment of the invention into a hard disk drive, the recording density and the lifespan thereof may be improved.

The following will give a more detailed description of the invention by exemplary embodiments.

### Embodiment 1

Performing the step S1-S3 shown in FIG. 5 step by step and cutting the wafer with compound read/write elements incorporated therein into a plurality of slices with a predetermined size, and forming a plurality of sample row bars (similar to the row bars 116 shown in FIG. 6b, i.e. a plurality of bars with a same structure) by such as a diamond cutter.

The sample row bar has a multi-filmed configuration as shown in FIGS. 2-4, which comprises an AlTiC base plate acting as the wafer of the substrate 1, an aluminum layer with a thickness of 5 μm functioning as the undercoat 2, a permalloy layer with a thickness of 2 μm serving as the bottom magnetic-shielding layer 3, a Ta layer with a thickness of 0.05 μm used as the first covering layer 4, a GMR element 20 (a more detailed illustration will be given later), a Ta layer with a thickness of 0.05 μm used as the second covering layer 7, a permalloy layer with a thickness of 4 μm as the top magnetic-shielding layer 8, and a NiFe layer with a thickness of 2 μm as the write gap layer 9. The top yoke layer 12 is made of permalloy, and the top pole 12a as a front end thereof has a height of 5 μm and a width of 0.5 μm. The overcoat 17 is formed by aluminum plate with a thickness of 30 μm.

In the GMR element 20, the base layer 25 is formed by sequent depositing several layers on the first covering layer 4. These layers include a Ta layer with a height of 3 nm, a permalloy layer with a height of 3 nm, a copper layer with a height of 20 nm and another permalloy layer with a height of 3 nm. The antiferromagnetic layer 24 is a PtMn layer having a thickness of 30 nm, the ferromagnetic layer 22 (pinned layer) is a CoFe layer having a thickness of 10 nm, the nonmagnetic layer 21 is a copper layer having a thickness of 1.9 nm, and the soft magnetic layer 23 (free layer) is a permalloy layer with a height of 3 nm. The cover layer 26 is a Ta layer with a height of 5 nm.

The sample row bars are secured to a fixture firstly, then contact with an abrasive plate. After that, a suspension solution consisting of diamond polishing powder is introduced to the abrasive plate while the abrasive plate is rotated so that the surfaces of the head elements and the sliders are lapped. Finally, the sample row bars are removed from the abrasive plate when the desired lapping amount is achieved. In this embodiment, each sample row bar has 50 pieces of sliders.

Next, on the lapping surface of the sample row bar, the base film, the first and second DLC films as the protecting film are formed by the manner listed in diagram 1.

The conditions of forming the first and second DLC films are as follows: the current of electric arc is 30A; the current applied to the electromagnetic coil is 9A so as to induct carbon ions; The electromagnetic coil used herein has a double-flex structure. The disk for loading the slider is a stainless steel disk and has a diameter of 210 mm. A bias voltage is applied to the disk and the disk has a rotatable structure for improving the uniformity thereof.

The sample row bars listed in diagram 1 are tested in these aspects: (1) first corrosion test; (2) secondary corrosion test; (3) FH σ(nm) measurement; and (4) surface resistance of the protecting film test.

The sample row bars are measured as the abovementioned manner and the carbon film densities of the first and second DLC films are also recorded.

First Corrosion Test

Putting the sample row bars into vitriol solution (PH=2) for 5 minutes. Then calculating the total number of the etched sliders. Here, an optical microscope is used for judging if the sliders have been etched. In the test, two sample row bars, 50*2=100 pieces of the sliders, are used as a sample radix.

Secondary Corrosion Test

Performing CSS (contact start stop) test for 30,000 times and then performing the same tests as that of the first corrosion test.

In the secondary corrosion test, the sample row bars are divided into respective sliders, and then assorting the individual sliders to do the tests.

The CSS (contact start stop) test is as follows: in a disk drive device or testing device loaded with the slider, the load gram of the slider is set to 2.5 g; then driving the recording medium from stationary state to a rotating state having a speed of 7,200 rpm in 3 seconds and keeping the rotating state for 3 seconds, and then stopping the rotating recording medium in 3 seconds and keeping the stationary state for 3 seconds. The operations described above are seemed as a CSS operation and such a CSS operation should be repeated for 30,000 times.

FH σ(nm) Measurement

In this measurement, fifty sliders are measured by a flying height measuring device to determine their flying heights and then a standard deviation σ is calculated. Here a 14 nm-type device is employed (read/write portion of datum disk and slider). the value of the FH σ(nm) is smaller, the change of the flying height is smaller. The small change of the flying height means the disk drive device having a good dynamic performance.

Surface Resistance of the Protecting Film Test

The test is performed as follows: forming DLC films (the first and second DLC films) having a thickness of 10 nm on the aluminum base plate, then configuring metal pads with a distance of 1 cm from each other and measuring the resistance therebetween. The voltages are set in 1V, 5V and 10V to measure the resistances and then calculate the average resistance thereof. The test results are listed in diagram 1 as below.

| | | | First DLC film | | | Second DLC film | | | | | | |
|---|---|---|---|---|---|---|---|---|---|---|---|---|
| | | | | Carbon | | | Carbon | | | | | |
| | | | | film | Film | | film | Film | | | | |
| | Cleaning | Base | Film forming | density | thickness | Film forming | density | thickness | FCT | SCT | FHσ | SR |
| | processing | film | method | (g/cm³) | (nm) | method | (g/cm³) | (nm) | (pcs/100) | (pcs/100) | (nm) | (Ω) |
| Em 1 | IBE | Si | FCVA(*0) | 2.9 | 1 | FCVA(*−25) | 3.1 | 1 | 3 | 5 | 0.8 | 1 × 10⁹ |
| Em 2 | IBE | Si | FCVA(*0) | 2.9 | 1 | FCVA(*−50) | 3.3 | 1 | 1 | 2 | 0.8 | 1 × 10⁹ |
| Em 3 | IBE | Si | FCVA(*0) | 2.9 | 1 | FCVA(*−75) | 3.4 | 1 | 1 | 2 | 0.8 | 1 × 10⁹ |
| Em 4 | IBE | Si | FCVA(*0) | 2.9 | 1 | FCVA(*−100) | 3.5 | 1 | 0 | 0 | 0.8 | 1 × 10⁹ |
| Em 5 | IBE | Si | FCVA(*0) | 2.9 | 1 | FCVA(*−150) | 3.2 | 1 | 2 | 3 | 0.8 | 1 × 10⁹ |
| Em 6 | IBE | Si | FCVA(*0) | 2.9 | 0.5 | FCVA(*−100) | 3.5 | 1 | 1 | 2 | 0.8 | 1 × 10⁹ |
| Em 7 | IBE | SiN | FCVA(*0) | 2.9 | 1 | FCVA(*−100) | 3.5 | 1 | 0 | 0 | 0.8 | 1 × 10⁹ |
| Cem 1 | IBE | Si | FCVA(*0) | 2.9 | 1 | FCVA(*0) | 2.9 | 1 | 6 | 9 | 0.8 | 1 × 10⁹ |
| CEm 2 | IBE | Si | — | — | 0 | FCVA(*−100) | 3.5 | 2 | 6 | 20 | 0.8 | 1 × 10⁹ |
| CEm 3 | SE | Si | FCVA(*0) | 2.9 | 1 | FCVA(*−100) | 2.3 | 1 | 100 | 100 | 1.8 | 1 × 10¹¹ |

FCT (First corrosion test); SCT (secondary corrosion test); SR (Surface resistance); CEm (Comparison embodiment); Em (embodiment)

In the diagram, IBE means Ion Beam Etching, SE means Sputter Etching, FCVA means Filtered Cathodic Vacuum arc and ECR means Electron Cyclotron Resonance. Also it is noted that the numbers behind the asterisk mark in the diagram is the value of the bias voltage applied thereto and its unit is volt.

As demonstrated in the diagram, the result of the invention is effective. The slider provided by the instant invention includes a substrate, head elements formed on the substrate and a protecting film formed on at least one portion of one surface of the substrate, wherein said surface faces the magnetic recording medium. Said protecting film comprises a first DLC (diamond like carbon) film and a second DLC film formed from the substrate. In the invention, the carbon film density of said first DLC film is less than 3.1 (g/cm³), whereas the carbon film density of said second DLC film is more than 3.1 (g/cm³). As a result, the protecting film of the invention not only has a thin thickness, but also is wearable and corrosive-resistive.

The slider of the invention may be incorporated in a personal computer or applied in any field where data storage devices are used.

1. A slider comprising:
a substrate;
head elements formed on the substrate; and
a protecting film formed on at least one portion of one surface of the substrate facing a magnetic recording medium, wherein:
said protecting film comprises a first DLC (diamond like carbon) film adjacent the substrate and a second DLC film;
the carbon film density of said first DLC film is less than 3.1 (g/cm³); and
the carbon film density of said second DLC film is more than 3.1 (g/cm³).

2. The slider according to claim 1, wherein a base film made mainly from silicon element is disposed between said substrate and said first DLC film.

3. The slider according to claim 2, wherein said base film made mainly from silicon element is constructed by material silicon, silica, silicon nitride or carborundum.

4. The slider according to claim 1, wherein the thickness of said first DLC film is ranged from 0.5 to 2.0 nm, and the thickness of said second DLC film is ranged from 1.0 to 2.0 nm.

5. The slider according to claim 1, wherein the surface resistance of the protecting film is ranged from 10⁷ to 10¹⁰ ohms.

6. A manufacturing method of a slider comprising:
a step of forming a head element on a substrate; and
a step of forming a protecting film on at least one portion of one surface of the substrate facing a magnetic recording medium, wherein
the step of forming the protecting film further comprises:
a step of forming a base film which is mainly made from silicon element on said substrate;
a step of forming a first DLC film on said base film such that the slider is grounded or floated; and
a step of forming a second DLC film on said first DLC film using catholic arc method and by applying a bias voltage on said first DLC film, said bias voltage ranging from −25V to −150V.

7. The method according to claim 6, wherein said bias voltage ranges from −25V to −100V.

8. The method according to claim 6, wherein a cleaning process is performed before forming said base film to clean the surface of the base film by ion beam etching (IBE) method.

9. The method according to claim 6, wherein said protecting film extends to at least a metal layer of the head element surface facing the magnetic recording medium.

10. A head suspension assembly, comprising:
a slider; and
a suspension, said slider is carried by said suspension at it's distal end and supported by said suspension, wherein:
said slider comprises:
a substrate;
a head element formed on the substrate; and
a protecting film formed on at least one portion of one surface of the substrate facing a magnetic recording medium;
said protecting film comprises:
a base film;
a first DLC (diamond like carbon) film adjacent the substrate; and
a second DLC film; wherein
the carbon film density of said first DLC film is less than 3.1 (g/cm3); and the carbon film density of said second DLC film is more than 3.1 (g/cm3).
